(19) United States
(12) Patent Application Publication
(10) Pub. No.: US 2017/0372263 A1
(43) Pub. Date: Dec. 28, 2017

(54) Methods and Systems for Aggregating Excess Carrier Capacity

(71) Applicant: Loxhub, LLC, Mundelein, IL (US)

(72) Inventor: Andrew J. Kim, Mundelein, IL (US)

(21) Appl. No.: 15/449,728

(22) Filed: Mar. 3, 2017

Related U.S. Application Data
(60) Provisional application No. 62/303,307, filed on Mar. 3, 2016.

(51) Int. Cl. G06Q 10/08

(52) U.S. Cl. CPC G06Q 10/0834; G06Q 10/08355; G06Q 10/0833

(57) ABSTRACT

A method of matching carriers to shippers is described. In an embodiment, the method comprises the steps of receiving carrier capacity data from a plurality of linked sources into a transportation database in a data processing system, wherein the carrier capacity data comprises a parameter for each linked source; saving the carrier capacity data; receiving a request for a requested route into the data processing system, wherein the request includes request data; comparing the parameter of each linked source to the request data; determining if the parameter of at least one linked source matches the request data; displaying a matched route for each at least one linked source for which the parameter matches the request data; and displaying each matched route on a graphical user interface.

### PRIORITY CLAIM

This application claims priority to U.S. Provisional Patent Application No. 62/303,307, filed Mar. 3, 2016, the disclosure of which is incorporated herein it its entirety.

### TECHNICAL FIELD OF THE INVENTION

This invention is directed to the field of transportation of freight by a carrier.

### BACKGROUND OF THE INVENTION

The ability of shippers to get parcels from a loading dock to a final destination in shorter time spans and at lower cost has improved in recent years. The growth of overnight carriers and the consistency of the two- and three-day delivery carriers have led to the creation of vast fleets of vehicles representing many transportation modes. The growth of shipping demand has fueled the development of the carriers' drive for efficiencies. Technological advances and better methods of doing business have in turn spurred greater demand for carrier services. The net result is that the volume of parcels being shipped has continued to spiral upward.

More often than not, however, a vehicle utilized by a carrier has “excess capacity.” That is, the maximum available space in the vehicle is not fully utilized for the movement of packages or parcels. For example, at takeoff, a plane may have a few cubic feet of space available for shipping; at rollout, a freight train may have some available container space; or, at final pick up, a truck may have some available space. Excess capacity, therefore, represents revenue or opportunity lost to the carrier. The present invention addresses the problem of lost revenue and opportunity.

### SUMMARY OF THE INVENTION

The preferred embodiment of the method of the present invention comprises a method of receiving carrier capacity data from a plurality of carriers into a transportation database in a data processing system, wherein the carrier capacity data identifies carrier capacity available by specific units of volume for a particular route at a particular time with a particular mode of transportation, receiving a request for a route into the data processing system, wherein the request includes one or more parameters of the requested route, comparing the requested route with the received carrier capacity data in the data processing system to determine whether or not a route match exists; and providing for display a list of matching routes on a graphical user interface.

One preferred embodiment of the present invention is a method, comprising the steps of:
receiving carrier capacity data from a plurality of linked sources into a transportation database in a data processing system, wherein the carrier capacity data comprises a parameter for each linked source;
saving the carrier capacity data;
receiving a request for a requested route into the data processing system, wherein the request includes request data;
comparing the parameter of each linked source to the request data;
determining if the parameter of at least one linked source matches the request data;
displaying a matching route for each at least one linked source for which the parameter matches the request data;
displaying a list of the matching routes on a graphical user interface;
receiving a selection of a matching route via the graphical user interface.
saving the matching route selection to a transaction database;
assigning a transaction code to the saved matching route selection; and
decrementing availability of the matching route selection from the data in the transportation database.

Another preferred embodiment is a non-transitory computer readable medium having stored thereon instructions, that when executed by one or more processors, cause a computing device to perform operations comprising:
receiving carrier capacity data from a plurality of linked sources into a transportation database in a data processing system, wherein the carrier capacity data comprises a parameter for each linked source;
saving the carrier capacity data;
receiving a request for a requested route into the data processing system, wherein the request includes request data;
comparing the parameter of each linked source to the request data;
determining if the parameter of at least one linked source matches the request data;
displaying a matching route for each at least one linked source for which the parameter matches the request data;
displaying a list of the matching routes on a graphical user interface;
receiving a selection of a matching route via the graphical user interface.
saving the matching route selection to a transaction database;
assigning a transaction code to the saved matching route selection; and
decrementing availability of the matching route selection from the data in the transportation database.

### BRIEF DESCRIPTION OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a schematic outline of the system of the preferred embodiment of the present invention.

FIGS. 2A-2AB are a series of screen captures from a graphical user interface demonstrating a first aspect of the system of FIG. 1.

FIGS. 3A-3E are a series of screen captures from a graphical user interface demonstrating a second aspect of the system of FIG. 1.

FIGS. 4A-4AE are a series of screen captures from a graphical user interface demonstrating a third aspect of the system of FIG. 1.

FIG. 5 is a simplified block diagram of a computing device used to facilitate the system of FIG. 1.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

Described herein are methods and systems for brokering carrier capacity that provide flexibility to shippers and can be used within the internal environment of one carrier or within a network of several carriers.

As used herein, “carrier” means a logistics company available for hire by the public to transport freight.

As used herein, “third-party logistics” or “freight broker” or “freight forwarder” means an intermediary between shippers and carriers.

As used herein, “online load boards” means online bulletin boards where shippers and truckers can post and actively manage freight loads through various forms of inefficient communication.

As used herein, “reverse auction” means an online auction style bidding by carriers for available loads.

As used herein, “brokering” refers to use of a system that acts as an intermediary between the shipper/user of carrier space and the carrier that has listed the space.

The method of the preferred embodiment of the invention comprises a number of steps. These steps occur over a dual path. One path allows entry of available carrier capacity, and the second path allows access to that available capacity. The method employs a data processing system, with a real-time clock, supporting an application that embodies the method. There are at least two entry points into the system. Each entry point has a real time clock as well as data entry means for entering either carrier capacity to the system or entering a request for available routes into the system, or both.

Path one involves receiving carrier capacity into a transportation database. Carrier capacity data comprises one or more parameters which may include, but are not limited to: amount of space or weight available; destination; dates and times; rates; mode of transport; and payment terms. Mode of transport would include, at least: air; ground; ship; rail; and/or mixed modal. Mixed modal is defined as the use of two or more modes of transport within a single route. Payment terms may include requirements for immediate payment or time periods for delayed payment. The received data is then confirmed, saved in the transportation database, and assigned a pre-transaction code.

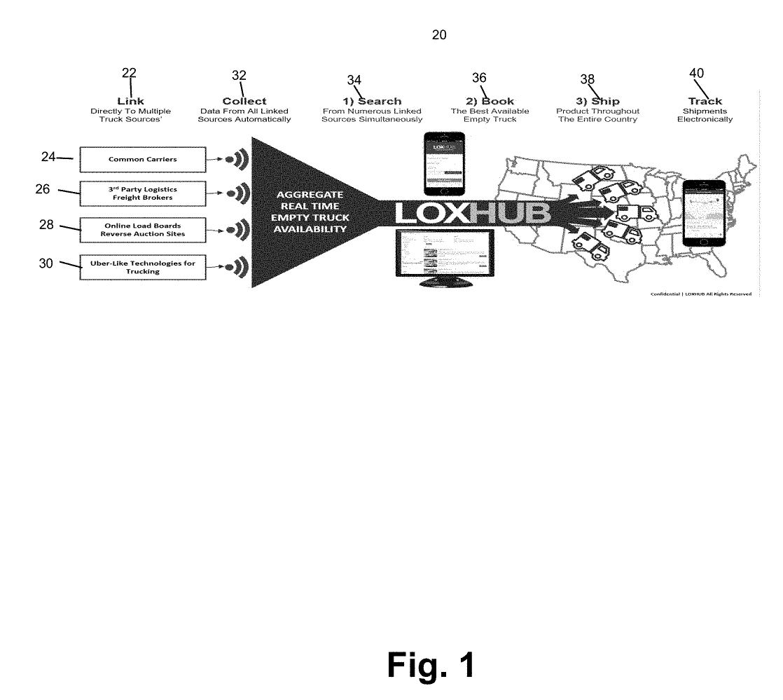

In one example, carrier capacity data is entered automatically into the transportation database. For example, as shown in FIG. 1, a data processing system 20 in a first step may collect carrier capacity data from a plurality of linked sources automatically. The plurality of linked sources 22 may include carriers 24, third-party logistics freight brokers 26, online load boards and reverse auction sites 28, or on-demand trucking applications 30. In such an example, each of the linked sources 22 subscribes to the data processing system 20 to enable data processing system 20 to aggregate and collect real-time empty-vehicle availability 32, through network links, telephone lines, cable systems, wireless links, or other communication protocols. Additionally, the system 20 may integrate with broker systems such that users may be redirected to the broker website to finish a transaction.

In another example, a carrier may upload its carrier capacity data manually to the transportation database through a network link, telephone line, cable system, wireless link, or other communication protocol. Moreover, the data may be uploaded automatically as part of an Application Program Interface (API) batch or similar upload.

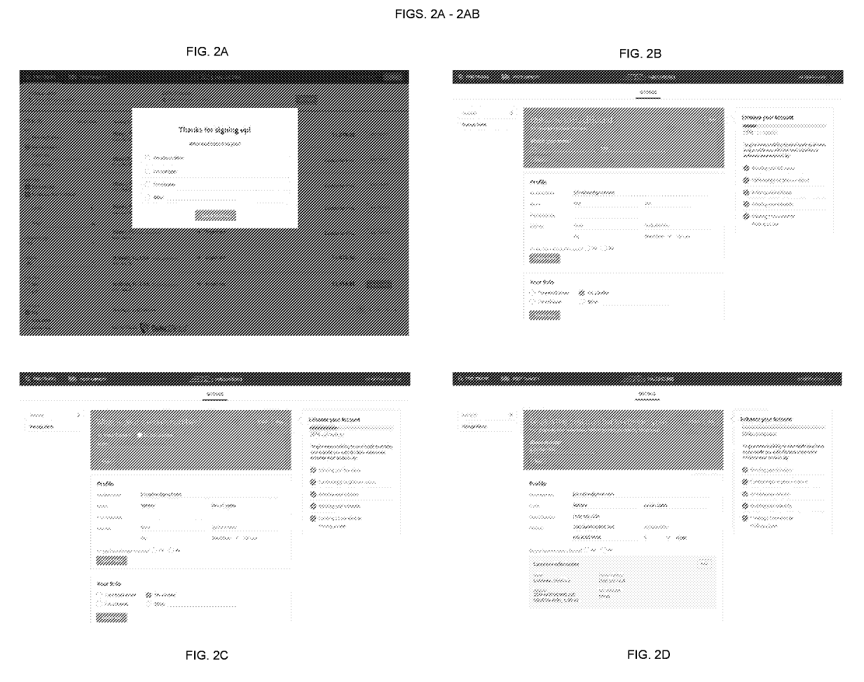

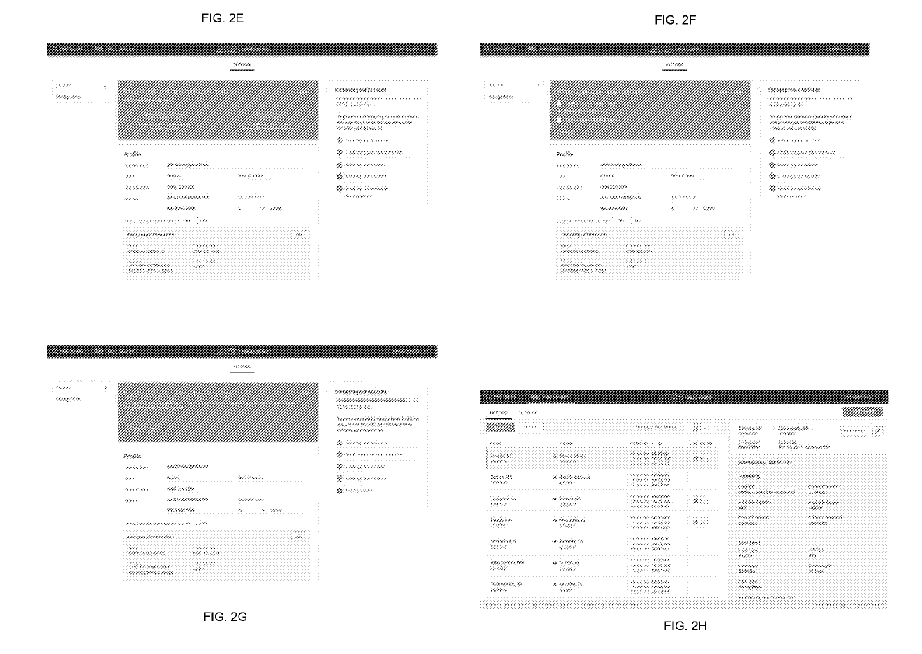

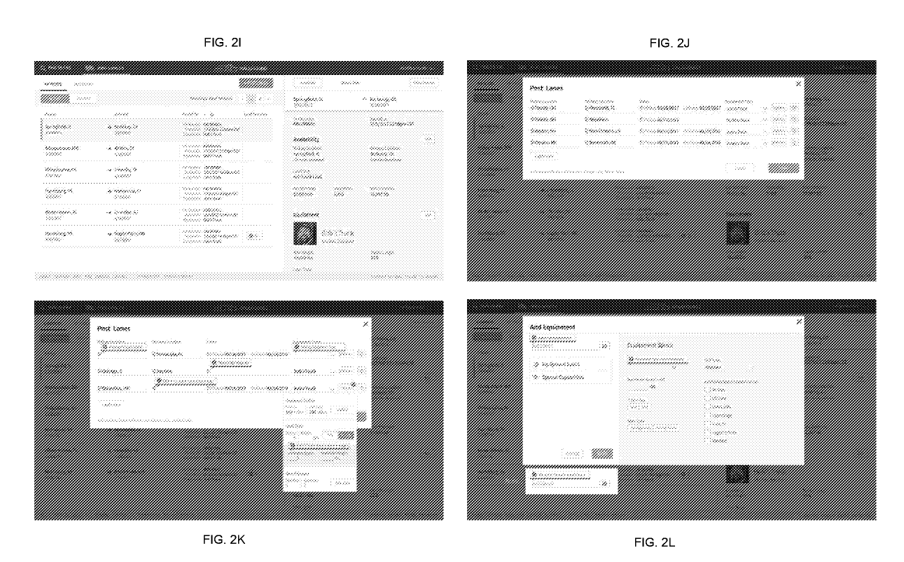

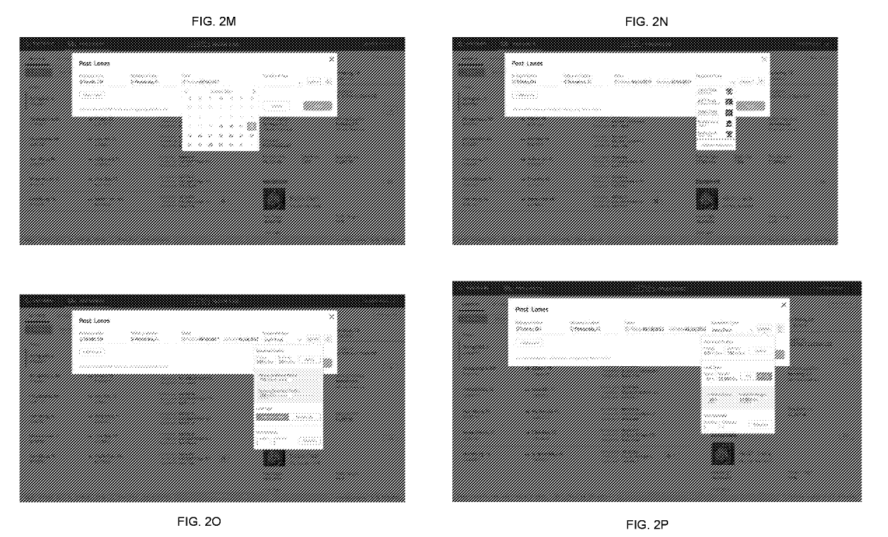

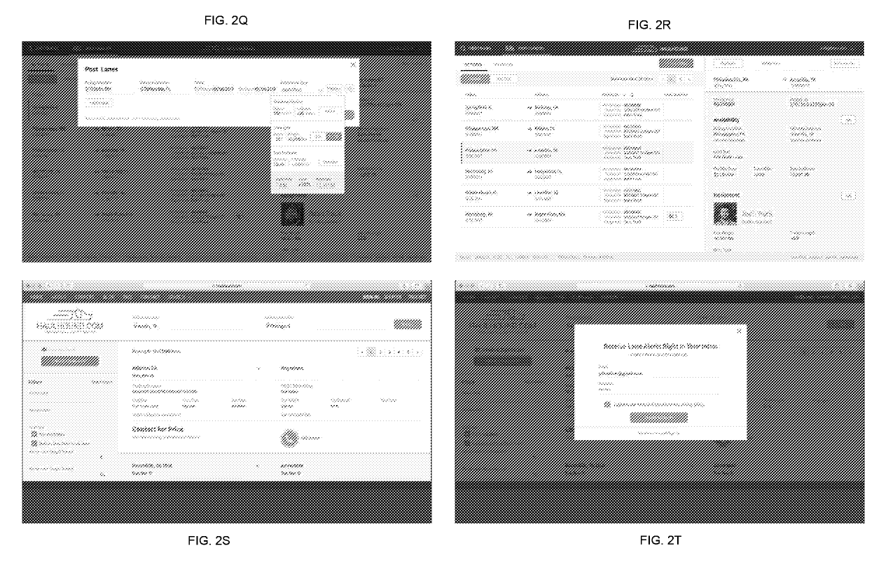

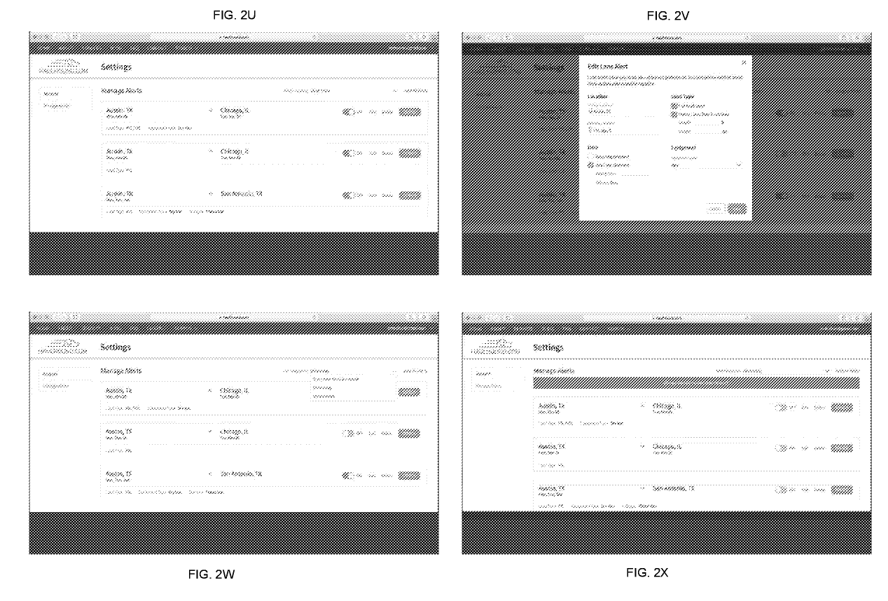

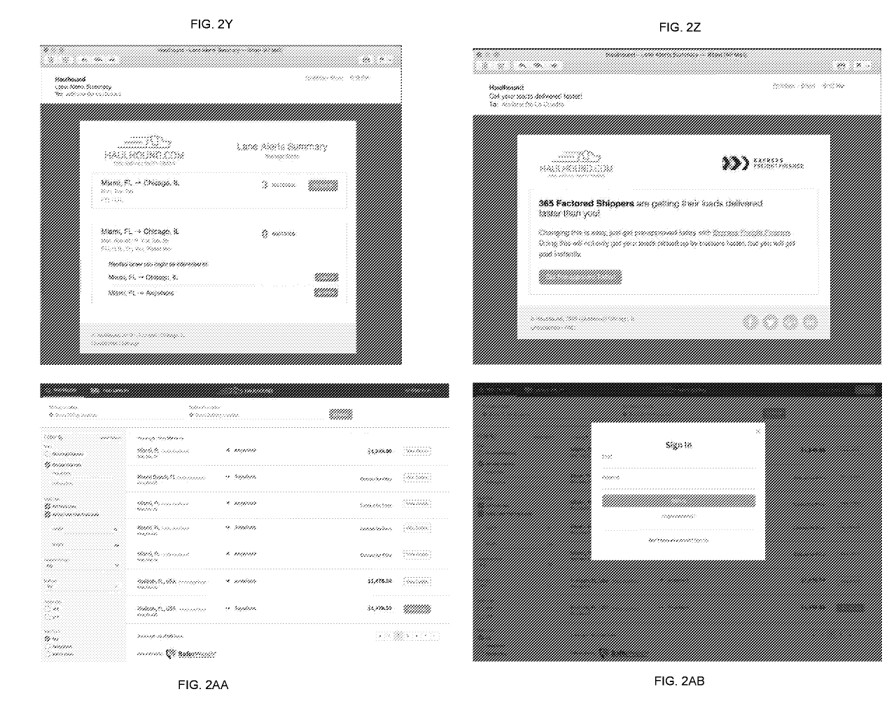

Path two involves a user entering a search request 34 for available capacity into the system by defining a requested route. The requested route is defined by request data which comprises parameters including but is not limited to: volume or weight required; destination; dates and times; rates; and mode of transport. The fewer parameters that are entered, the greater the scope of the search. FIGS. 2A-2AB illustrate an example graphical user interface 50 through which a user can enter a request 34 for available shipping capacity.

The system 20 utilizes data processing means for determining whether a match can be found between a request 34 for available capacity and what empty truck availability has actually been entered into the transportation database. The system operator making the request 34 for a route is provided with a display of the request 34 made as well as a display of the matched entries. See FIGS. 2A-2AB. The display means being preferably a monitor, operatively connected to the data processing system, or a screen on a smartphone. The system operator can then select an appropriate matched entry from among those displayed. The selection must then be confirmed. Upon confirmation, the selected matched entry is saved to a transaction database, assigned a transaction code, and booked 36. The assignment of a transaction code can then be the initiating step in preparing a bill for services, generating a transaction report, or initiating the shipping process 38. The system may also provide an option to track 40 the package once the selection is confirmed.

FIGS. 2A-2AB illustrates an example display of the list of matching routes on the graphical user interface 50. As shown in FIGS. 2A-2AB, the graphical user interface may further include a plurality of filters for the list of matching routes on the graphical user interface 50. For example, as shown in FIGS. 2A-2AB, the filters may include sorting the results by time, price, types of trucks, or goods. Further, as shown in FIGS. 2A-2AB, the graphical user interface 50 may further include a pricing bar to select a range of prices. In such examples, the method may further include receiving a selection of one of the plurality of filters via the graphical user interface 50, and responsively providing for display a subset of the list of matching routes on the graphical user interface 50. In addition, the graphical user interface may provide advertisements in the logistics realm, as well as a feature to invite friends via email, text, and social media. It is further contemplated that a rewards program will be offered to incentivize users.

Within path two of the method, there exists the possibility that no match will be found between what is available and what has been requested. If a null response is received when the requested route is compared with the listing of available capacity entered into the transportation database, then the requested route data is saved to a request database.

A request database locator program is activated within the data processing system for the purpose of querying the transportation database at pre-determined time intervals to determine if a matching route selection has been entered into the transportation database subsequent to the initial request. If a matching route selection has been entered into the transportation database, then a prompt is sent, for example, to the display device that initiated the route request along with other affiliated devices designated for receipt of the prompt by that user. The prompt indicates that a match has been found and that the system operator should enter the application to confirm the match.

If, however, a matching route selection has not been entered into the transportation database, then the request database locator program will continue to query the transportation database at pre-determined time intervals until either the date and time of the requested route has exceeded the date and time (i.e., a time/date threshold) on the real time clock of the data processing system, or until the query is terminated by the system operator.

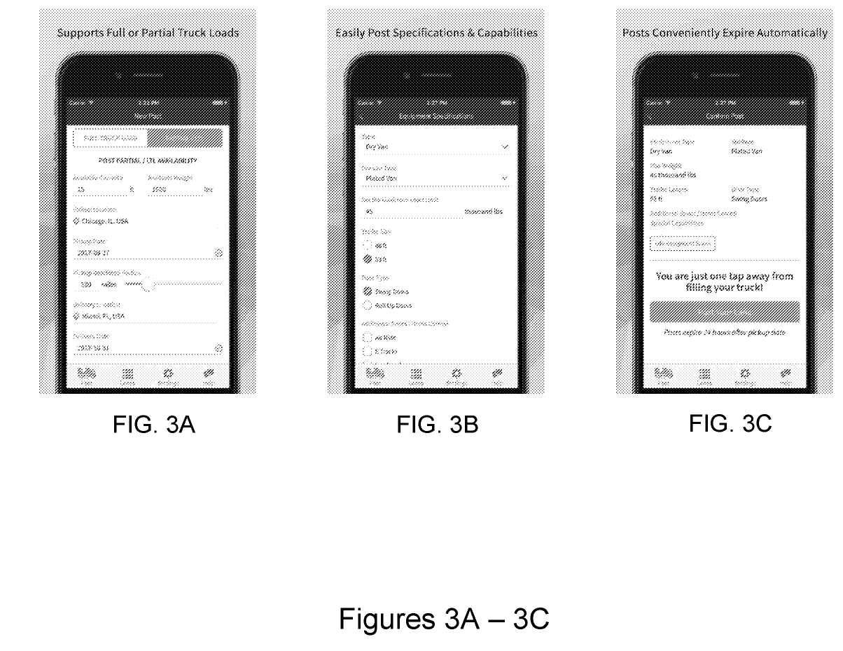

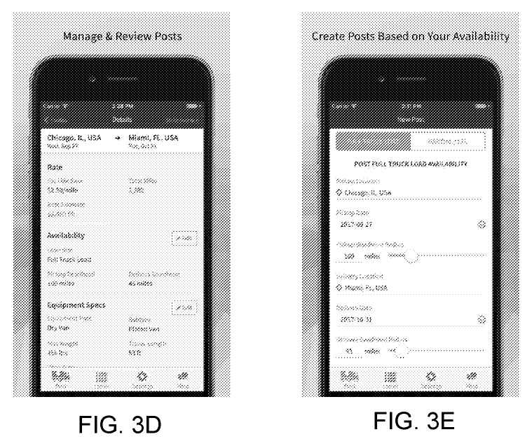

FIGS. 3A through 3E illustrate a mobile application for path two of the method from the shipper side. As illustrated in FIG. 3A, the graphical user interface 50 may display a request for a pickup location, a delivery location, and an arrival date. In another example, a user may select search for routes that are within a variable radius of the pickup location and/or a variable radius from the delivery location. For example, the graphical user interface 50 may provide a drop-down menu or a slider to select that the pickup location must be within 5, 10, 25, or 50 miles from the user's current location. Other distances are possible as well. In one example, the graphical user interface 50 of the mobile application may capture information from a camera on the mobile device, such as driver's license information, insurance authority, bills of lading, invoices, and proof of delivery. The use of optical character recognition (“OCR”) and video relay service (“VRS”) technology may be integrated into the data transfer to import that information quickly for improved onboarding of users.

The shipper may offer a full truck load or a partial or less-than-truck load (“LTL”). As shown in FIG. 3A, the shipper may also offer, for example, full container load or a partial or less-than-container load. FIG. 3A shows an offer for an LTL load. The availability in either volume or weight, or both, is shown.

Further, as shown in FIG. 3B, options such as the types of vehicle, maximum load, trailer size, door type, and other options are shown. Posted routes are displayed for a pre-set period, such as 24 hours as shown in FIG. 3C. The shipper can review the post before finalizing it, as shown in FIG. 3D.

Further, the graphical user interface 50 may display a list of matching routes, and the user may select a given route to receive more information on that particular route. The user may then book the truck by selecting the “Book Truck” option. In some embodiments, the user will be directed to the shipping provider's website to finalize the booking process. The graphical user interface 50 may further include a map illustrating the route from the pickup location to the delivery location, including any intermediate stops.

The graphical user interface 50 may also include a bar to select a range of prices to be displayed, a selection of the type of vehicle the user desires the goods to be shipped in, the size and height of the package or packages to be delivered, and information about the package(s) such as whether the package(s) are flammable, hazardous, or corrosive.

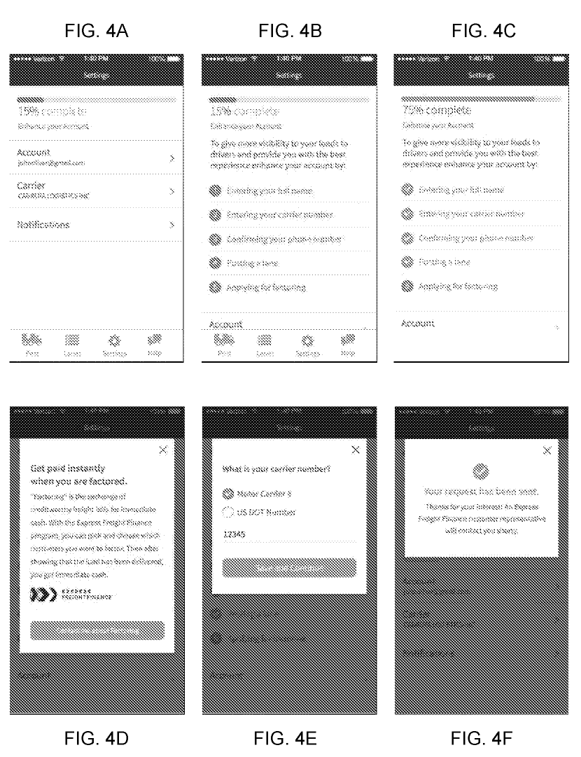

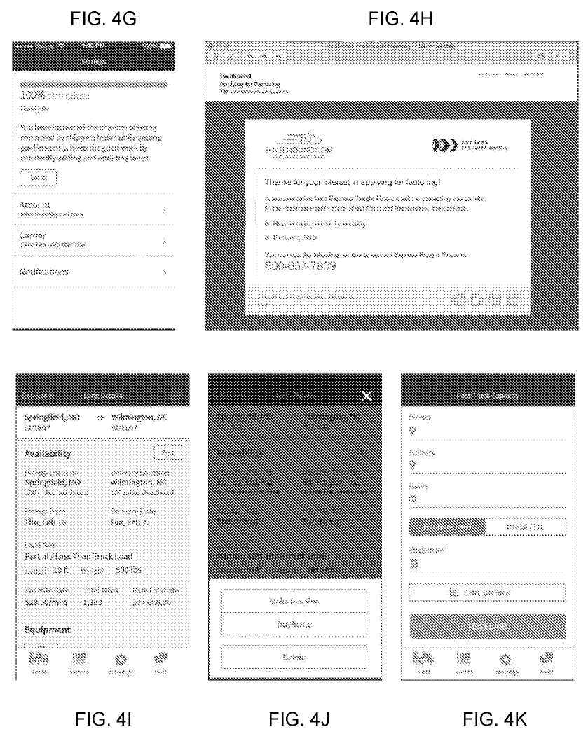

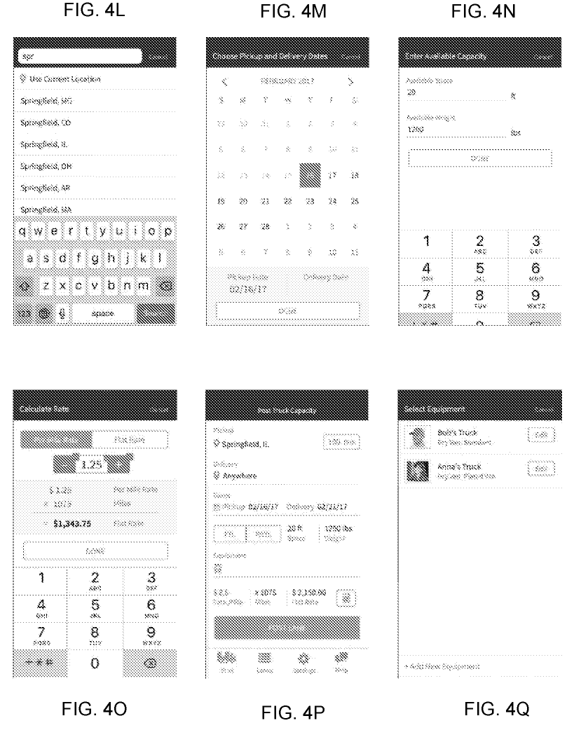

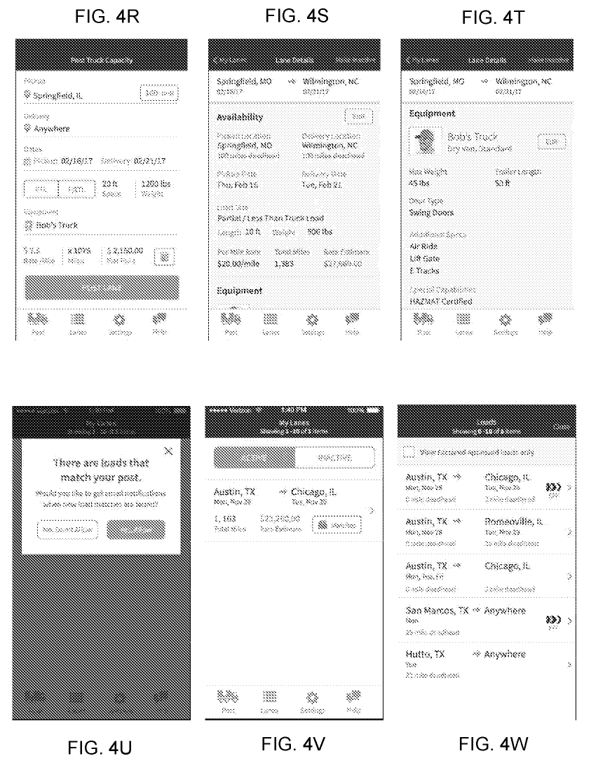

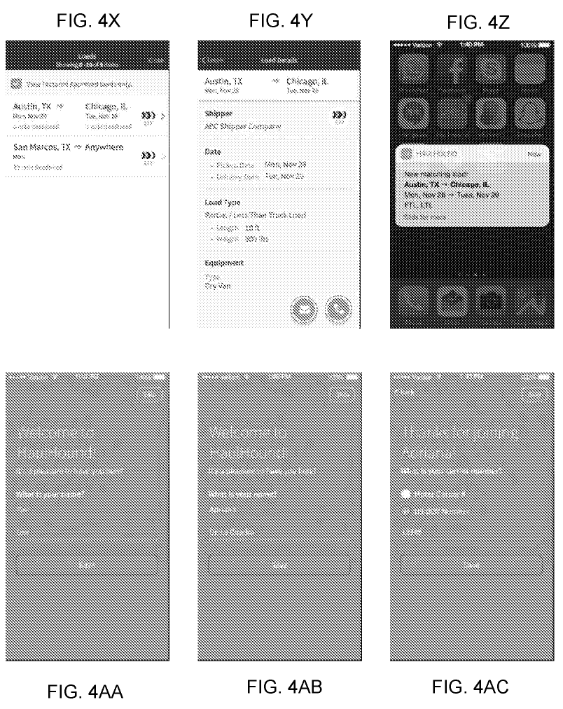

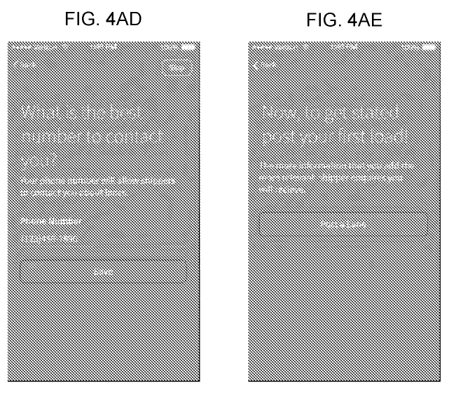

FIGS. 4A-4AE illustrate a mobile application for path one of the method from the shipping provider side. A shipping provider may have a profile in the mobile application, and the shipping provider may enter information about the shipping provider in the profile. In one example, the graphical user interface 50 of the mobile application may capture information from a camera on the mobile device, such as driver's license information, insurance authority, and bills of ladings as examples and quickly import that information for improved onboarding of shipping providers. Further, the profile for a given shipping provider may receive a message when a new load is booked. The shipping provider may select the new load to show details about that load, including a map of the route, the details of the package(s) to be shipped, and the timing of the shipment. Once the package(s) have been shipped, the mobile application may provide information on the status of the shipment until final delivery.

When system 20 displays a route, it may also display a profile for the carrier, or a link to a profile. A requester may also set a lane alert, whereby when a shipper's offered rate meets a predetermined amount, the requester receives an alert, such as a text message, an email, or an alarm, informing the requester of the posted predetermined rate. A bidding system may be provided wherein shippers will bid on an open lane and truckers will have a predefined period of time to accept the bid. System 20 may also alert truckers when there are unfilled requests for routes. Additionally, system 20 may include a capability of communicating with an electronic logging device for capturing driver metrics data, such as hours on the road per day.

System 20 may also include route segmenting, whereby a primary route may be segmented into one or more secondary stops between the primary route origin and primary route destination. For example, if a trucker is seeking a shipping route from Los Angeles to New York, system 20 may provide an indication of one or more intermittent shipments to be made along the primary route, such as a stop in Chicago. In that way, a driver is able to determine the availability of shipments along the entire radius of the primary route, as opposed to just having access to shipments from one primary endpoint (i.e., Los Angeles) to the other (i.e., New York).

System 20 may include billing and invoicing processes and direct digital payment. Moreover, in order to mitigate risks of non-payment, system 20 may provide a means for drivers to understand whether certain shippers have been “pre-approved” for credit. In that way, if a trucker takes on a load from a particular shipper, the trucker will know whether there exists an opportunity to be paid right away through factoring. System 20 may also include a rating system for shippers and for carriers, a dock mapping tool to assist drivers and shippers, navigation (including points of interest, such as truck stops, scales, hotels, rest stops, and speed traps), fleet management tools (such as tracking oil changes and tire rotations), and GPS to determine truck location and instances of speed limit violations.

System 20 may also include tracking information for shippers, to determine the specific location of a carrier vehicle during the time of transportation. Additionally, a communication and data platform may be made available so supply chain vendors and third party logistics organizations can manage all steps of the supply chain. System 20 may also include a messaging service. Preferably, the messaging service includes proxy emails and proxy telephone lines to mask the actual contact. System 20 may include advertising, including directed advertising. Moreover, shipping insurance may be offered, for example at booking 36, through exclusive insurance partners. System 20 may include predictive analytics, forecasting, and machine learning on route optimization, heat maps, traffic patterns, seasonal analytics, and dynamic pricing. System 20 may include combination logistics for intermodal shipments. System 20 may include background testing for job placement, online staffing for trucking companies to hire qualified and well-rated but temporary drivers, and dedicated logistics for shippers that want a particular trucking company or particular driver.

System 20 may also integrate with risk management software. System 20 may include a social media platform for drives and logistics professionals to meet up and create or manage events. System 20 may also display podcasts for logistics professionals.

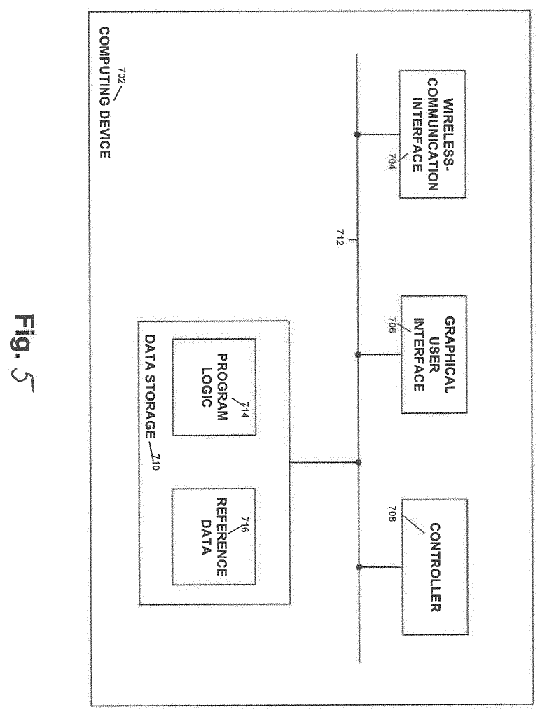

Those skilled in the art will appreciate that there may be numerous specific implementations of a computing device that may be used in connection with at least one embodiment of the method described herein. By way of example, FIG. 5 is a simplified block diagram of a computing device 702, showing functional components that can be included in such a device 702 to facilitate implementation of at least one embodiment of the methods described above. By way of example and without limitation, computing device 702 may be a cellular mobile telephone (e.g., a smartphone), mobile device, desktop computer, email/messaging device, tablet computer, or similar device that may be configured to perform the functions described herein.

As shown, the example computing device 702 may include a wireless-communication interface 704, a graphical user interface 706, a controller 708, and data storage 710, all of which may be coupled together by a system bus 712 or by a network, or other connection mechanism.

The wireless-communication interface 704 may be or include any combination of hardware and software modules that a computing device may use to communicate in a wireless manner with one or more other entities. As such, the wireless-communication interface 704 may have one or more chipsets suitable for wireless communication, and/or one or more other components suitable for engaging in data communication.

The graphical user interface system 706 may include one or more input and/or output components to facilitate interaction with a user of the computing device 702. As such, the graphical user interface 706 may include input components such as a mouse, keypad, touchpad, touch-sensitive display, microphone, and camera, and the graphical user interface 706 may further include output components such as a display screen and a sound speaker or headset jack. Other input and output components are possible as well.

The controller 708 may include one or more general purpose processors (e.g., microprocessors) and/or one or more special purpose processors (e.g., digital signal processors, application specific integrated circuits, etc.) and may be integrated in whole or in part with the wireless-communication interface and/or other components of the computing device.

The data storage 710 may include one or more volatile and/or non-volatile storage components, such as optical, magnetic, flash, or other storage components, and may be integrated in whole or in part with the controller 708. The data storage 710 may include any type of non-transitory computer-readable medium or media, such as a storage device that includes a disk and/or a hard drive, as examples. The computer-readable medium may include media arranged to store data for short periods of time, such as register memory, processor cache, and/or random access memory (RAM), as examples. The computer-readable medium may also or instead include media arranged to serve as secondary or more persistent long-term storage, such as read only memory (ROM), optical disks, and/or magnetic disks, as examples. The computer-readable media may also or instead include any other volatile and/or non-volatile storage system or systems deemed suitable for a given implementation.

As shown, representative data storage 710 may include program logic 714 and reference data 716. The program logic 714 may include instructions executable by the controller 708 to carry out various functions of the computing device 702 described herein. The non-transitory data storage 710 may also hold reference data 716 for use in accordance with the present method.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Because many modifications, variations, and changes in detail can be made to the described example, it is intended that all matters in the preceding description and shown in the accompanying figures be interpreted as illustrative and not in a limiting sense.

I claim:

1. A method, comprising:
receiving carrier capacity data from a plurality of linked sources into a transportation database in a data processing system, wherein the carrier capacity data comprises a parameter for each linked source;
saving the carrier capacity data;
receiving a request for a requested route into the data processing system, wherein the request includes request data;
comparing the parameter of each linked source to the request data;
determining if the parameter of at least one linked source matches the request data;
displaying a matching route for each at least one linked source for which the parameter matches the request data;
displaying a list of the matching routes on a graphical user interface.

2. The method of claim 1, further comprising:
receiving a selection of a matching route via the graphical user interface.

3. The method of claim 2, further comprising:
saving the matching route selection to a transaction database;
assigning a transaction code to the saved matching route selection; and
decrementing availability of the matching route selection from the data in the transportation database.

4. The method of claim 1, wherein the linked sources comprise at least one of a common carrier, a third-party logistics freight broker, an online load board, a reverse auction site, and an on-demand trucking application.

5. The method of claim 1, wherein the parameter comprises at least one of an amount of available space, an amount of available weight, a route origin, a route destination, a date, a time, a rate, and a mode of transport.

6. The method of claim 5, wherein the mode of transport comprises at least one of air transport, ground transport, ship transport, and rail transport.

7. The method of claim 1, wherein the data processing system utilizes a real time clock such that the data processing system can determine when carrier capacity listed in the data processing system can no longer be accessed because of a time/date threshold.

8. The method of claim 1, wherein a transaction code is assigned to said matching route selection.

9. The method of claim 1, wherein one or more of the matching routes may be segmented into one or more secondary stops between the primary origin of the matching route and the primary destination of the matching route.

10. The method of claim 1, wherein if a null response is received when the requested route is compared with the list of routes entered into the transportation database, then the requested route data is saved to a request database.

11. The method of claim 10, wherein a request database locator program is activated within the data processing system for the purpose of querying the transportation database at pre-determined time intervals to determine if a matching route selection has been entered into the transportation database.

12. The method of claim 1, wherein receiving the request for the route comprises receiving a location start point of the route and a location end point of the route by causing the start point and the end point to be entered into the data processing means by scanning said start point and said end point into said data processing system with a scanner or optical character reader from a label of a parcel to be shipped or from a printed media.

13. The method of claim 1, further comprising:
providing for display a plurality of filters for the list of matching routes on the graphical user interface.

14. The method of claim 13, further comprising:
receiving a selection of one of the plurality of filters via the graphical user interface; and
providing for display a subset of the list of matching routes on the graphical user interface.

15. A non-transitory computer readable medium having stored thereon instructions, that when executed by one or more processors, cause a computing device to perform operations comprising:
receiving carrier capacity data from a plurality of linked sources into a transportation database in a data processing system, wherein the carrier capacity data comprises a parameter for each linked source;
saving the carrier capacity data;
receiving a request for a requested route into the data processing system, wherein the request includes request data;
comparing the parameter of each linked source to the request data;
determining if the parameter of at least one linked source matches the request data;
displaying a matching route for each at least one linked source for which the parameter matches the request data;
displaying a list of the matching routes on a graphical user interface.

16. The non-transitory computer readable medium of claim 15, wherein the operations further comprise:
receiving a selection of a matching route from the list of matching routes via the graphical user interface.

17. The non-transitory computer readable medium of claim 16, wherein the operations further comprise:
saving the matching route selection to a transaction database;
assigning a transaction code to the saved matching route selection; and
decrementing availability of said matching route selection from said data in said transportation database.

18. The non-transitory computer readable medium of claim 15, wherein the operations further comprise:
providing for display a plurality of filters for the list of matching routes on the graphical user interface.

19. The non-transitory computer readable medium of claim 18, wherein the operations further comprise:
receiving a selection of one of the plurality of filters via the graphical user interface; and
providing for display a subset of the list of matching routes on the graphical user interface.

20. The non-transitory computer readable medium of claim 15, wherein the operations further comprise one or more of the matching routes being segmented into one or more secondary stops between the primary origin of the matching route and the primary destination of the matching route.
